(19) United States
(12) Patent Application Publication
(10) Pub. No.: US 2022/0358499 A1
(43) Pub. Date: Nov. 10, 2022

(54) METHOD AND SYSTEM FOR AUTONOMOUS PORTFOLIO PLATFORM MANAGEMENT

(71) Applicant: JPMorgan Chase Bank, N.A., New York, NY (US)

(72) Inventor: Ankur SAMBHAR, Thane West (IN)

(73) Assignee: JPMorgan Chase Bank, N.A., New York, NY (US)

(21) Appl. No.: 17/354,689

(22) Filed: Jun. 22, 2021

(30) Foreign Application Priority Data
May 7, 2021 (IN) 202111020840

(51) Int. Cl. G06Q 20/40; G06Q 40/04; G06Q 10/10; G06Q 20/38; G06F 9/451

(52) U.S. Cl. CPC G06Q 20/405; G06Q 40/04; G06Q 10/10; G06Q 20/389; G06F 9/451; G06Q 2230/00; G06Q 40/08

(57) ABSTRACT

A method for facilitating self-management of an investment portfolio using smart contracts is provided. The method includes: displaying a user interface that includes prompts for facilitating user input relating to the investment portfolio; receiving, via the user interface, proposed rules for executing trades relating to the investment portfolio; retrieving news information relating to the investment portfolio; analyzing the rules and the retrieved news information to determine trades to be executed with respect to a financial instrument; executing the trades; and transmitting, to the user interface, a message that includes explanatory information relating to each trade. A smart contract that is generated based on the proposed rules may be displayed on the user interface, and the smart contract may also be installed on a blockchain that is accessible to other prospective investors, thereby facilitating additional input regarding proposed rules for executing trades.

### CROSS-REFERENCE TO RELATED APPLICATIONS

This application claims priority benefit from Indian Application No. 202111020840, filed May 7, 2021, which is hereby incorporated by reference in its entirety.

### BACKGROUND

### 1. Field of the Disclosure

This technology generally relates to methods and systems for managing an investment portfolio, and more particularly to methods and systems for providing an autonomous platform for facilitating self-management of an investment portfolio using smart contracts.

### 2. Background Information

Conventionally, an investor either manages his/her own investment portfolio, or the investor hires a portfolio manager to perform the portfolio management function. Managing an investment portfolio requires making many decisions about which securities to buy and sell, in what amounts, timing each transaction, and balancing the distribution of assets, among other decisions.

When an individual investor manages his/her own portfolio, each decision is based on his/her own research, which may be less extensive that that which would typically be performed by a professional portfolio manager. Further, even when a professional is hired to manage a portfolio, the decisions are completely based on the professional portfolio manager's research and/or thought process. In this aspect, it is very possible that a manager may overlook important information, such as any political instability, a natural disaster, a potential company acquisition or merger, personnel changes, or other relevant information, which may adversely impact a trading decision. In addition, there is always a possibility of human error due to poor judgment and/or time pressure associated with making such decisions.

Accordingly, there is a need for a mechanism to enable an investor to leverage a self-managed autonomous platform using smart contracts that facilitate access to relevant information that is applicable to multiple investors and transparency with respect to rules governing the portfolio.

### SUMMARY

The present disclosure, through one or more of its various aspects, embodiments, and/or specific features or sub-components, provides, inter alia, various systems, servers, devices, methods, media, programs, and platforms for providing an autonomous platform for facilitating self-management of an investment portfolio using smart contracts.

According to an aspect of the present disclosure, a method for providing an autonomous platform for facilitating self-management of an investment portfolio using smart contracts is provided. The method is implemented by at least one processor. The method includes: displaying, by the at least one processor, a user interface that includes at least one prompt for facilitating data input that relates to the investment portfolio to be provided by a user; receiving, by the at least one processor via the user interface, at least one proposed rule that relates to the investment portfolio; retrieving, by the at least one processor, news information that relates to the investment portfolio; analyzing, by the at least one processor, the at least one proposed rule and the retrieved news information to determine a first trade to be executed with respect to a financial instrument; executing, by the at least one processor, the first trade; and transmitting, by the at least one processor to the user interface, a message that includes explanatory information that relates to the executed first trade.

The analyzing may include determining whether to buy or sell the financial instrument, determining an amount of the financial instrument to be traded, and determining a time interval during which the first trade is to be executed.

The method may further include: generating, by the at least one processor, a smart contract that is based at least in part on the at least one proposed rule; and displaying the smart contract on the user interface. The smart contract may be installed on a blockchain mechanism that is accessible by a plurality of prospective investors.

The displaying of the smart contract may include displaying information that indicates criteria that governs a future determination to execute a future trade that relates to the investment portfolio.

When a newly proposed rule is received from at least one from among the plurality of prospective investors and the newly proposed rule is accepted as an elected rule by election of the plurality of prospective investors, the method may further include modifying the smart contract based on the elected rule.

The at least one rule may relate to at least one from among a return on investment (ROI) associated with the financial instrument, a risk exposure associated with the financial instrument, and an industry sector associated with the financial instrument.

The at least one rule may relate to at least one from among a credit rating of a company associated with the financial instrument, news information that relates to a commercial interaction of the company associated with the financial instrument, and news information that relates to an election result.

According to another exemplary embodiment, a computing apparatus for facilitating self-management of an investment portfolio is provided. The computing apparatus includes a processor; a memory; and a communication interface coupled to each of the processor and the memory. The processor is configured to: display a user interface that includes at least one prompt for facilitating data input that relates to the investment portfolio to be provided by a user; receive, via the user interface and the communication interface, at least one proposed rule that relates to the investment portfolio; retrieve, via the communication interface, news information that relates to the investment portfolio; analyze the at least one proposed rule and the retrieved news information to determine a first trade to be executed with respect to a financial instrument; execute the first trade; and transmit, to the user interface via the communication interface, a message that includes explanatory information that relates to the executed first trade.

The processor may be further configured to determine the first trade by determining whether to buy or sell the financial instrument, determining an amount of the financial instrument to be traded, and determining a time interval during which the first trade is to be executed.

The processor may be further configured to: generate a smart contract that is based at least in part on the at least one proposed rule; and display the smart contract on the user interface. The smart contract may be installed on a blockchain mechanism that is accessible by a plurality of prospective investors.

The processor may be further configured to display, in conjunction with the smart contract, information that indicates criteria that governs a future determination to execute a future trade that relates to the investment portfolio.

When a newly proposed rule is received from at least one from among the plurality of prospective investors and the newly proposed rule is accepted as an elected rule by election of the plurality of prospective investors, the processor may be further configured to modify the smart contract based on the elected rule.

The at least one rule may relate to at least one from among a return on investment (ROI) associated with the financial instrument, a risk exposure associated with the financial instrument, and an industry sector associated with the financial instrument.

The at least one rule may relate to at least one from among a credit rating of a company associated with the financial instrument, news information that relates to a commercial interaction of the company associated with the financial instrument, and news information that relates to an election result.

According to yet another exemplary embodiment, a non-transitory computer readable storage medium storing instructions for facilitating self-management of an investment portfolio is provided. The storage medium includes executable code which, when executed by a processor, causes the processor to: display a user interface that includes at least one prompt for facilitating data input that relates to the investment portfolio to be provided by a user; receive, via the user interface, at least one proposed rule that relates to the investment portfolio; retrieve news information that relates to the investment portfolio; analyze the at least one proposed rule and the retrieved news information to determine a first trade to be executed with respect to a financial instrument; execute the first trade; and transmit, to the user interface, a message that includes explanatory information that relates to the executed first trade.

The executable code may be further configured to cause the processor to generate a smart contract that is based at least in part on the at least one proposed rule; and display the smart contract on the user interface. The smart contract may be installed on a blockchain mechanism that is accessible by a plurality of prospective investors.

The executable code may be further configured to cause the processor to display, in conjunction with the displaying of the smart contract, information that indicates criteria that governs a future determination to execute a future trade that relates to the investment portfolio.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing an autonomous platform for facilitating self-management of an investment portfolio using smart contracts.

FIG. 4 is a flowchart of an exemplary process for implementing a method for providing an autonomous platform for facilitating self-management of an investment portfolio using smart contracts.

FIG. 5 is a data flow diagram that illustrates a flow of data through an autonomous platform for facilitating self-management of an investment portfolio using smart contracts, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

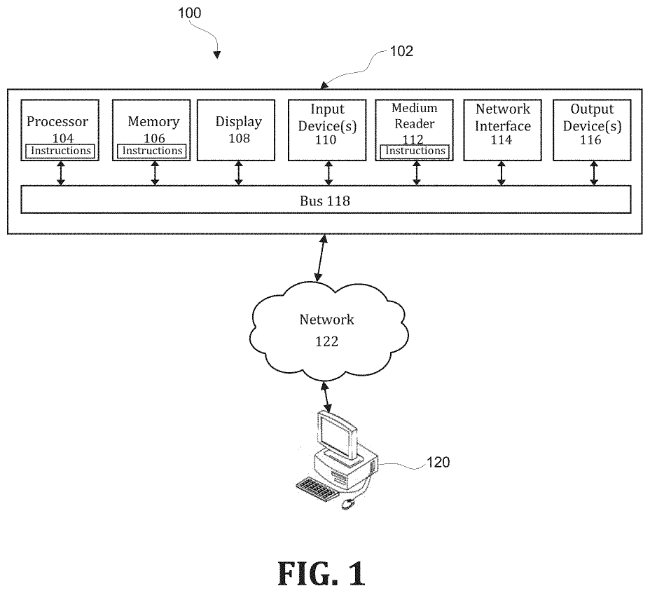

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing an autonomous platform for facilitating self-management of an investment portfolio using smart contracts.

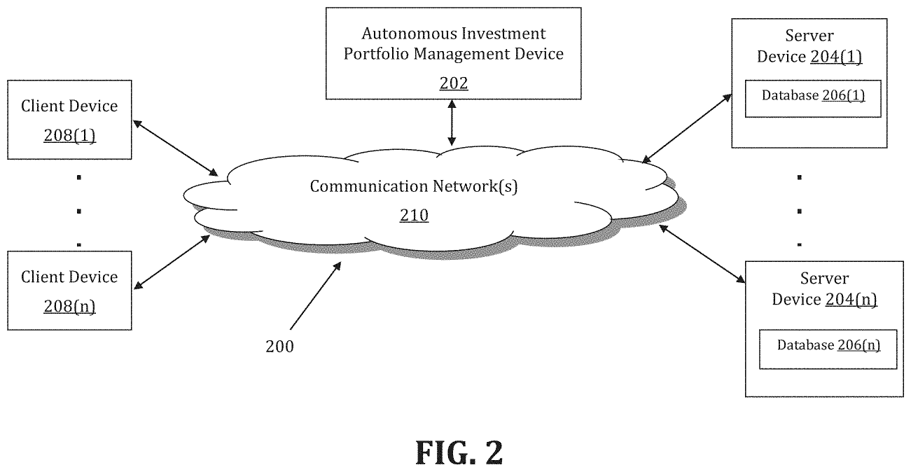

Referring to FIG. 2, a schematic of an exemplary network environment 200 for implementing a method for providing an autonomous platform for facilitating self-management of an investment portfolio using smart contracts is illustrated. In an exemplary embodiment, the method is executable on any networked computer platform, such as, for example, a personal computer (PC).

The method for providing an autonomous platform for facilitating self-management of an investment portfolio using smart contracts may be implemented by an Autonomous Investment Portfolio Management (AIPM) device 202. The AIPM device 202 may be the same or similar to the computer system 102 as described with respect to FIG. 1. The AIPM device 202 may store one or more applications that can include executable instructions that, when executed by the AIPM device 202, cause the AIPM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AIPM device 202 itself, may be located in virtual server(s) running in a cloud-based computing environment rather than being tied to one or more specific physical network computing devices. Also, the application(s) may be running in one or more virtual machines (VMs) executing on the AIPM device 202. Additionally, in one or more embodiments of this technology, virtual machine(s) running on the AIPM device 202 may be managed or supervised by a hypervisor.

In the network environment 200 of FIG. 2, the AIPM device 202 is coupled to a plurality of server devices 204(1)-204(n) that hosts a plurality of databases 206(1)-206(n), and also to a plurality of client devices 208(1)-208(n) via communication network(s) 210. A communication interface of the AIPM device 202, such as the network interface 114 of the computer system 102 of FIG. 1, operatively couples and communicates between the AIPM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AIPM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and AIPM devices that efficiently implement a method for providing an autonomous platform for facilitating self-management of an investment portfolio using smart contracts.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AIPM device 202 may be a standalone device or integrated with one or more other devices or apparatuses, such as one or more of the server devices 204(1)-204(n), for example. In one particular example, the AIPM device 202 may include or be hosted by one of the server devices 204(1)-204(n), and other arrangements are also possible. Moreover, one or more of the devices of the AIPM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AIPM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to market analyses that affect many investment portfolios and investor-specific data that relates to individual investment portfolios.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AIPM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AIPM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AIPM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AIPM device 202, the server devices 204(1)-204(n), or the client devices 208(1)-208(n), for example, may be configured to operate as virtual instances on the same physical machine. In other words, one or more of the AIPM device 202, the server devices 204(1)-204(n), or the client devices 208(1)-208(n) may operate on the same physical device rather than as separate devices communicating through communication network(s) 210. Additionally, there may be more or fewer AIPM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

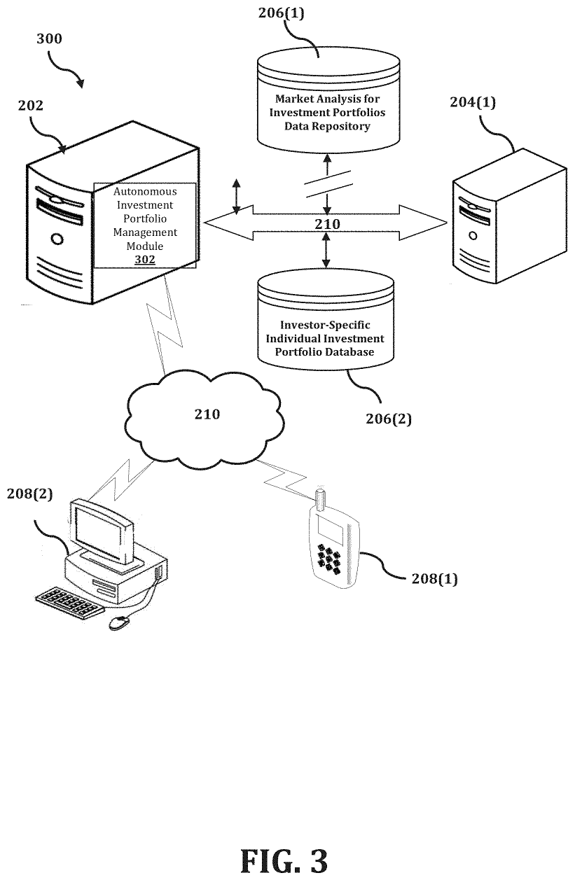

The AIPM device 202 is described and illustrated in FIG. 3 as including an autonomous investment portfolio management module 302, although it may include other rules, policies, modules, databases, or applications, for example. As will be described below, the autonomous investment portfolio management module 302 is configured to implement a method for providing an autonomous platform for facilitating self-management of an investment portfolio using smart contracts.

An exemplary process 300 for implementing a mechanism for providing an autonomous platform for facilitating self-management of an investment portfolio using smart contracts by utilizing the network environment of FIG. 2 is illustrated as being executed in FIG. 3. Specifically, a first client device 208(1) and a second client device 208(2) are illustrated as being in communication with AIPM device 202. In this regard, the first client device 208(1) and the second client device 208(2) may be “clients” of the AIPM device 202 and are described herein as such. Nevertheless, it is to be known and understood that the first client device 208(1) and/or the second client device 208(2) need not necessarily be “clients” of the AIPM device 202, or any entity described in association therewith herein. Any additional or alternative relationship may exist between either or both of the first client device 208(1) and the second client device 208(2) and the AIPM device 202, or no relationship may exist.

Further, AIPM device 202 is illustrated as being able to access a market analysis for investment portfolios data repository 206(1) and an investor-specific individual investment portfolio database 206(2). The autonomous investment portfolio management module 302 may be configured to access these databases for implementing a method for providing an autonomous platform for facilitating self-management of an investment portfolio using smart contracts.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the AIPM device 202 via broadband or cellular communication. Of course, these embodiments are merely exemplary and are not limiting or exhaustive.

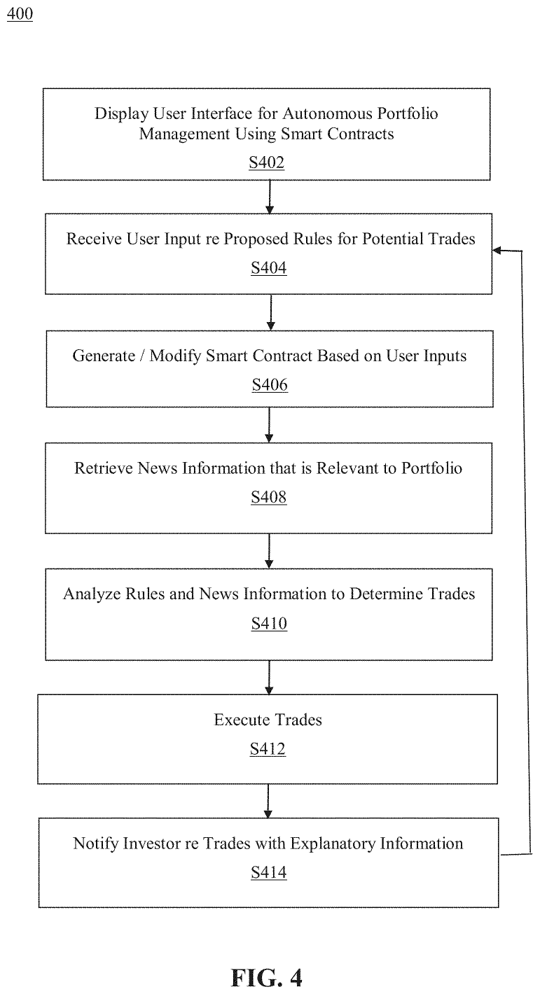

Upon being started, the autonomous investment portfolio management module 302 executes a process for providing an autonomous platform for facilitating self-management of an investment portfolio using smart contracts. An exemplary process for providing an autonomous platform for facilitating self-management of an investment portfolio using smart contracts is generally indicated at flowchart 400 in FIG. 4.

In process 400 of FIG. 4, at step S402, the autonomous investment portfolio management module 302 displays a user interface for autonomous investment portfolio management using smart contracts on a display of a user, such as, for example, an investor. The user interface includes prompts for facilitating data input to be provided by the user.

In an exemplary embodiment, a smart contract is generated and displayed on the user interface. The smart contract may include information that indicates criteria that govern a further determination to execute a future trade relating to the investment portfolio.

At step S404, the autonomous investment portfolio management module 302 receives input relating to one or more proposed rules for executing trades and managing the investment portfolio from the user via the user interface. In an exemplary embodiment, the proposed rules may relate to any one or more of a return on investment (ROI) associated with a financial instrument to be traded, a risk exposure associated with the financial instrument, and an industry sector associated with the financial instrument. The proposed rules many also relate to any one or more of a credit rating of a company associated with the financial instrument; news information that relates to a commercial interaction of the company, such as a merger, an acquisition, or an action relating to personnel; news information that relates to externalities that affect the company, such as an election result; and/or any other relevant types of news information.

At step S406, the autonomous investment portfolio management module 302 generates or modifies the smart contract based on the user inputs received in step S404. Then, in step S408, the autonomous investment portfolio management module 302 retrieves news information that is relevant to the investment portfolio. In an exemplary embodiment, the retrieval of news information may entail accessing news from many sources via the Internet and/or via any suitable method for obtaining news information.

At step S410, the autonomous investment portfolio management module 302 analyzes the rules and the retrieved news information to determine one or more trades to be executed. In an exemplary embodiment, the analyzing includes determining whether to buy or sell a particular financial instrument; determining an amount of the financial instrument to be traded, i.e., a number of shares of stock to be traded or an equivalent amount of currency to be transacted; and determining a time interval during which a trade is to be executed. Then, in step S412, the autonomous investment portfolio management module 302 executes the trade determined as a result of the analysis performed in step S410.

At step S414, the autonomous investment portfolio management module 302 notifies the investor about the executed trade. In an exemplary embodiment, the notification may be effected by transmitting a message that includes information relating to the trade and explanatory information that relates to how the applicable rules were invoked and what news information was retrieved to trigger the decision to execute the trade.

In an exemplary embodiment, the smart contract is installed on a blockchain mechanism, and access to the smart contract via the blockchain may be provided to a predetermined plurality of prospective investors. In this manner, the user may wish to gain a benefit of receiving inputs from other investors, based on the notion that when multiple investors have similar investment goals, the probability of making good decisions will increase as a result of the increased number of inputs. In this aspect, when the smart contract is accessible by multiple investors, each such investor may provide input relating to proposed rules and/or proposed rule changes at step S404, and then, at step S406, the smart contract may be modified based on the newly received input when a newly proposed rule is accepted as an elected rule as a result of an election by the group of investors. The process 400 also recursively enables further inputs and modifications by returning to step S404 after a particular trade is executed at step S412 and a notification is provided at step S414.

In an exemplary embodiment, a user may leverage a self-managed autonomous platform using smart contracts which will manage the portfolio. A bank of financial institution will provide a platform that will allow the investors to create their own self-managed autonomous portfolio manager. Investors can create the portfolio manager for the specific goals, such as return on investment (ROI), risk exposure, specific sector, and any other suitable goals, and will be governed by the rules defined in smart contract.

For example, some of the rules could be as follows: 1) If the company/instrument credit rating is downgraded by a reputed firm by X ounces, then sell the position. 2) If X company has signed a long-term deal with a government, invest Y % in X company. 3) If X political party wins a particular election, increase investment in infrastructure companies by Y %, as one of the primary agenda items of X party is infrastructure reforms.

In an exemplary embodiment, these rules will be defined based on the consensus across the investors using the platform. Once the rules are defined and associated with the portfolio manager, the rules will drive the decisions around the portfolio.

In an exemplary embodiment, smart contracts will pull external world data from the oracles and will make the decisions based on the rules defined in the smart contract. Oracles will provide data for prices, corporate events, political events, and other suitable events from around the world and provide the data to the portfolio smart contract. Data oracles will also be specified by the investors through consensus.

An investor will be able to enter/exit from the portfolio by sending a transaction to the smart contract. In case of exit, the smart contract will transfer the amount to the address specified by the investor. As a variation, the smart contract may leverage an M-of-N multi-signature approval process before processing the entry/exit request.

Users aligned to the goals of a specific portfolio will invest in that portfolio. Based on the investments, users will receive the voting rights to determine the execution of the decision.

For the same, bank can charge a flat fee for the platform from all of the users. Bank can also choose to publish the platform for free and instead generate revenues through trading fees. This would allow the bank to attract many new customers.

Benefits: 1) According to an exemplary embodiment, the process is based on proven research that relates to “Wisdom of Crowd”. So if multiple users with the same financial goals take a decision, the probability of the decision being correct is generally higher. 2) Once the rules are created, the process will be executed through smart contracts, which will ensure trustworthiness. 3) Smart contracts will also provide the required transparency around the rules governing the portfolio, thereby eliminating the uncertainty on how the portfolio will behave in a given market condition. This will also allow the user to exit the portfolio well in time if the use is uncomfortable with the prospective invocation of certain rules in the near future. 4) The operating cost of the portfolio management will be significantly reduced, as most of the decisions will be executed through smart contracts. 5) An additional revenue stream for a bank will be generated by charging a flat fee for the platform subscription or creation of a customized portfolio. 6) Banks will create the portfolio platform and will attach it to their trading services. An additional benefit to the banks will be the fees that they will generate through the trading and custodian services extended to the portfolio.

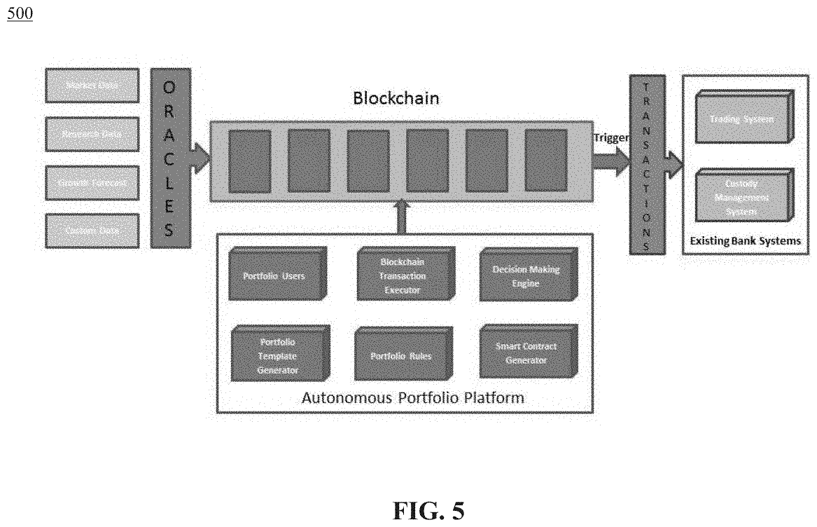

FIG. 5 is a data flow diagram 500 that illustrates a flow of data through an autonomous platform for facilitating self-management of an investment portfolio using smart contracts, according to an exemplary embodiment. An autonomous portfolio platform will contain various modules which will allow the user to create an on-demand portfolio backed by smart contracts. The portfolio will specify the various external dependencies that will be used in generating the rules for a smart contract. Based on the rules, the platform will buy/sell the stocks from the portfolio using bank's existing trading platform.

In an exemplary embodiment, an autonomous portfolio platform includes the following components: 1) Portfolio Manager Generator: This component (also referred to herein as “Portfolio Template Generator” is responsible for generating a specific portfolio manager aligned to user goals. 2) Portfolio Rules System: Allows a user to create the rules which will be associated with the given portfolio. This set of rules will govern how the portfolio will react to the various market events. 3) Portfolio Users: Contains details of the users associated with the given portfolio. 4) Smart Contract Generator: Contains the logic of generating the smart contract based on the rules specified for the given portfolio. 5) Decision Making Engine: Handles user inputs while deciding the rules through user consensus. These rules will govern the smart contracts. 6) Blockchain Transaction Executor: Once the smart contracts are created, this component will put those contracts on the existing block chain. 7) Data Oracles: Smart contracts depend on data from the outside world (outside of blockchain) to be able to make decisions. These data will be provided to the smart contracts through the Data Oracles.

In an exemplary embodiment, an autonomous platform for facilitating self-management of an investment portfolio using smart contracts is quite different from conventional algorithmic trading. In particular, in the case of algorithmic trading, the logic of trading in terms of algorithm is not public; only the owner of the algorithm has the details of it and keeps it proprietary. Therefore, when any other investor would like to leverage such logic, the algorithm cannot be changed, to suit to their need, and the investor must use the algorithm as is. Also, the set of users cannot autonomously decide their own rules to drive the algorithm. Further, in most cases, algorithmic trading does not have any user intervention for decision making to allow the transaction. By contrast, according to an exemplary embodiment, users will be allowed to define the smart contracts which will let the transaction happen only based on the predefined consensus threshold.

Accordingly, with this technology, an optimized process for providing an autonomous platform for facilitating self-management of an investment portfolio using smart contracts is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for facilitating self-management of an investment portfolio, the method being implemented by at least one processor, the method comprising:
displaying, by the at least one processor, a user interface that includes at least one prompt for facilitating data input that relates to the investment portfolio to be provided by a user;
receiving, by the at least one processor via the user interface, at least one proposed rule that relates to the investment portfolio;
retrieving, by the at least one processor, news information that relates to the investment portfolio;
analyzing, by the at least one processor, the at least one proposed rule and the retrieved news information to determine a first trade to be executed with respect to a financial instrument;
executing, by the at least one processor, the first trade; and
transmitting, by the at least one processor to the user interface, a message that includes explanatory information that relates to the executed first trade.

2. The method of claim 1, wherein the analyzing comprises determining whether to buy or sell the financial instrument, determining an amount of the financial instrument to be traded, and determining a time interval during which the first trade is to be executed.

3. The method of claim 1, further comprising:
generating, by the at least one processor, a smart contract that is based at least in part on the at least one proposed rule; and
displaying the smart contract on the user interface,
wherein the smart contract is installed on a blockchain mechanism that is accessible by a plurality of prospective investors.

4. The method of claim 3, wherein the displaying of the smart contract comprises displaying information that indicates criteria that governs a future determination to execute a future trade that relates to the investment portfolio.

5. The method of claim 3, wherein when a newly proposed rule is received from at least one from among the plurality of prospective investors and the newly proposed rule is accepted as an elected rule by election of the plurality of prospective investors, the method further comprises modifying the smart contract based on the elected rule.

6. The method of claim 1, wherein the at least one rule relates to at least one from among a return on investment (ROI) associated with the financial instrument, a risk exposure associated with the financial instrument, and an industry sector associated with the financial instrument.

7. The method of claim 1, wherein the at least one rule relates to at least one from among a credit rating of a company associated with the financial instrument, news information that relates to a commercial interaction of the company associated with the financial instrument, and news information that relates to an election result.

8. A computing apparatus for facilitating self-management of an investment portfolio, the computing apparatus comprising:
a processor;
a memory; and
a communication interface coupled to each of the processor and the memory,
wherein the processor is configured to:
display a user interface that includes at least one prompt for facilitating data input that relates to the investment portfolio to be provided by a user;
receive, via the user interface and the communication interface, at least one proposed rule that relates to the investment portfolio;
retrieve, via the communication interface, news information that relates to the investment portfolio;
analyze the at least one proposed rule and the retrieved news information to determine a first trade to be executed with respect to a financial instrument;
execute the first trade; and
transmit, to the user interface via the communication interface, a message that includes explanatory information that relates to the executed first trade.

9. The computing apparatus of claim 8, wherein the processor is further configured to determine the first trade by determining whether to buy or sell the financial instrument, determining an amount of the financial instrument to be traded, and determining a time interval during which the first trade is to be executed.

10. The computing apparatus of claim 8, wherein the processor is further configured to:
generate a smart contract that is based at least in part on the at least one proposed rule; and
display the smart contract on the user interface,
wherein the smart contract is installed on a blockchain mechanism that is accessible by a plurality of prospective investors.

11. The computing apparatus of claim 10, wherein the processor is further configured to display, in conjunction with the smart contract, information that indicates criteria that governs a future determination to execute a future trade that relates to the investment portfolio.

12. The computing apparatus of claim 10, wherein when a newly proposed rule is received from at least one from among the plurality of prospective investors and the newly proposed rule is accepted as an elected rule by election of the plurality of prospective investors, the processor is further configured to modify the smart contract based on the elected rule.

13. The computing apparatus of claim 8, wherein the at least one rule relates to at least one from among a return on investment (ROI) associated with the financial instrument, a risk exposure associated with the financial instrument, and an industry sector associated with the financial instrument.

14. The computing apparatus of claim 8, wherein the at least one rule relates to at least one from among a credit rating of a company associated with the financial instrument, news information that relates to a commercial interaction of the company associated with the financial instrument, and news information that relates to an election result.

15. A non-transitory computer readable storage medium storing instructions for facilitating self-management of an investment portfolio, the storage medium comprising executable code which, when executed by a processor, causes the processor to:
display a user interface that includes at least one prompt for facilitating data input that relates to the investment portfolio to be provided by a user;
receive, via the user interface, at least one proposed rule that relates to the investment portfolio;
retrieve news information that relates to the investment portfolio;
analyze the at least one proposed rule and the retrieved news information to determine a first trade to be executed with respect to a financial instrument;
execute the first trade; and
transmit, to the user interface, a message that includes explanatory information that relates to the executed first trade.

16. The storage medium of claim 15, wherein the executable code is further configured to cause the processor to:
generate a smart contract that is based at least in part on the at least one proposed rule; and
display the smart contract on the user interface,
wherein the smart contract is installed on a blockchain mechanism that is accessible by a plurality of prospective investors.

17. The storage medium of claim 16, wherein the executable code is further configured to cause the processor to display, in conjunction with the displaying of the smart contract, information that indicates criteria that governs a future determination to execute a future trade that relates to the investment portfolio.
